(19) United States
(12) Patent Application Publication
(10) Pub. No.: US 2005/0137965 A1
(43) Pub. Date: Jun. 23, 2005

(54) Business method involving home construction using attic trusses to enhance appraised value, mortgaging appraised value with a less-than-fully-amortized loan and investing the surplus and normal principal pay-down amount

(76) Inventor: Jeffery A. Fisk, Provo, UT (US)

Correspondence Address: Angus C. Fox, III, 4093 N. Imperial Way, Provo, UT, 84604-5386, US

(21) Appl. No.: 10/740,112

(22) Filed: Dec. 17, 2003

(51) Int. Cl. G06F 17/60

(52) U.S. Cl. 705/38; 705/34

(57) ABSTRACT

A method of doing business includes at least the steps of: constructing a home using attic trusses to minimize construction costs per unit size and maximize the above-grade size thereof; selling the home for less than its appraised value, in order to provide a buyer with equity in the home; and arranging financing using a mortgage that is less than fully amortized. The method may further include: establishing a business entity having construction, sales, mortgage brokering, and investment functions; providing credit clean-up services to prospective buyers; providing multiple home designs from which the buyer may select; arranging an initial financing or a subsequent refinancing of the home at or in excess of its appraised value; and providing investment services which enable the buyer to invest an amount corresponding to at least a partial pay-back of principal on a conventional long-term mortgage.

### BACKGROUND OF THE INVENTION

1. Field of the Invention

This invention relates generally to:
methods for constructing single-family dwellings;
methods for enhancing the appraised value of those homes without a proportionate increase in building costs;
methods of financing those homes using loans involving less than full amortization; and
methods for investing funds that would ordinarily have been used for mortgage principal pay back.

2. History of the Prior Art

From 1914 to 1983, the U.S. Consumer Price Index (CPI) escalated by a factor of 10. From the latter date to the present, the CPI has nearly doubled. In those same periods, the median price of a home in the U.S. has gone from about $2,500 in 1914 to about $70,000 in 1983. In the score of years since 1983, the median price of a home has increased very nearly 250 percent. In California, the median price of a home is expected to be $414,000 by 2004. One of the driving factors in housing prices outpacing the CPI is the Home Mortgage Interest Deduction. Today, that deduction pays up to 28 percent of a home buyer's mortgage interest. With the Federal Government subsidizing, say, 25 percent of housing costs, buyers are less price-sensitive during sales negotiations. This phenomenon has only been exacerbated by the ready supply of low-interest money for mortgages. This is a classic case of more money chasing fewer goods. Certainly, the scarcity of land in desirable locations, such as the coastal areas of the country, is an important factor in the run-up of housing prices. So too is the increasing scarcity of timber available for lumber.

Although the dramatic increase in housing prices is felt by the majority of Americans, families having combined annual incomes of less than $30,000 are hit particularly hard. According to Beth Shulman's new book, The Betrayal of Work, even in the expansionary decade of the '90s, one out of every four American workers made less than $8.70 an hour (about $18,000 a year with no vacation), an income equal to the government's poverty level for a family of four. Many, if not most, of these workers have no health care, sick pay or retirement provisions. For this sizeable group of individuals, home ownership is virtually unattainable. And, in spite of the propaganda which we are fed by the politicians in power, the financial situation for the masses in the U.S. will likely get worse, and the ranks of households having income of less than $30,000 a year will swell.

The moneyed elite in this country convinced us that GATT and NAFTA would deliver a new era of prosperity for the U.S. and the rest of the world. The elimination of trade barriers would improve not only our economy, but those of every other nation. Prices paid to U.S. farmers would increase, our exports would increase, and income both here and abroad would grow dramatically. However, since the ushering in of those treaties, jobs have left the U.S., and incomes have declined. At first, only menial jobs migrated to third-world countries such as Mexico and China. Then, a sizeable portion of the automotive manufacturing sector was transplanted to Mexico, and the U.S. textile industry moved, primarily, to Mexico and China. Food began pouring into this country from outside its borders. In response to the flood of foreign food imports, U.S. farm prices declined. Only highly trained individuals working in high technology fields seemed immune from the effects of GATT and NAFTA. Now, however, even the high-tech positions are being outsourced. Major U.S. companies, such as the Bank of America, Texas Instruments, Intel, Lehman Brothers, Bear Stearns, Hewlett Packard, American Express, Dell Computer, Eastman Kodak, IBM, GE, Microsoft, Procter & Gamble, and even Massachusetts General Hospital are hiring high-tech workers in the Philippines, India, China, Russia, Eastern Europe, Costa Rica and South Africa. Because nearly all educated Indians speak fluent English, India will initially be one of the biggest winners in the new global economy. Indian radiologists interpret CT scans for Massachusetts General, Indian engineers design mobile-phone chips for Texas Instruments, Indian engineers design software for Microsoft, and Indian office workers process US insurance claims and home loan applications. Multinational corporations based in the U.S. can hire college-educated Indian nationals for about $5,000 a year—an 80 to 90 percent savings over what they had to pay American workers. According to the Feb. 3, 2003 issue of Business Week, about 4 million U.S. jobs have been relocated to India. Frontline World reported last year that over half of Fortune 500 companies have moved jobs offshore. More are expected to follow.

Ironically, Indian workers can outcompete American and British workers today because Britain destroyed India's ability to compete in the past. Having destroyed India's own industrial infrastructure, the East India Company and the colonial authorities obliged its people to speak English, adopt British working practices and surrender their labor to the Company. The colonial order Britain established is sustained by the heirs to the East India Company—the multinational corporations. These corporations operate in their self interest. Sometimes this self interest benefits a disadvantaged group, but only at the expense of another.

Already, it is clear that China will be the juggernaut to reckon with in the future. Lester Thurow, former dean of MIT's Sloan School of Management, recently visited mexico, India, and Turkey. Everywhere, he says, people are concerned about outsourcing business to China. In the last three years, Mexico has lost 200,000 maquiladora jobs on its northern border to China. Thurow predicts that in ten years, China's 1,500 auto parts makers will manufacture 30 percent of the world's car parts. Within twenty years, China will likely become a dominant player in the manufacturing of complete autos. China is, in fact, is rapidly becoming the manufacturing center for all that defines the American culture of consumption: our TVs, computers, electronics, sporting goods, clothing, footware, and pianos.

Alan Tonelson has very competently documented the slide in American wages in his book, The Race to the Bottom: Why a Worldwide Worker Surplus and Uncontrolled Free Trade are Sinking American Living Standards. The book should be required reading for every U.S. politician.

Not only is the pressure on U.S. wages coming from outside the country, it is also coming from within. Millions of legal and illegal immigrants have created such a rapidly-expanding supply of unskilled and semi-skilled labor that the minimum wage has become the norm, rather than the exception for many industries and, particularly, for the semi-skilled service sector. Our politicians pretend to be concerned for the plight of the American worker, yet they receive the most political benefit by supporting the agenda of the multinational corporations (major campaign contributors) and pandering to the immigrant community (a large voting block in may districts). With the free trade agreements and our immigration policies, we have created a situation where scores of millions of individuals residing in the U.S. will not be able to escape poverty—no matter how hard they work. This country may have already seen its best days. The casual exploitation of the lower classes has become the foundation on which the prosperity of the ruling and upper classes is based. Though such a system is hardly new, it is inherently unstable.

The appraisal of residential property is generally be performed in one of two ways: The first is a Sales Comparison, or Market Value, Approach; and the second is a Cost Approach.

Using the Cost Approach, the appraiser estimates the cost to replace the subject property. The cost of the land is determined, then the cost to replace the improvements is added. Finally, the appraiser deducts for depreciation if necessary. The following different types of depreciation are considered: Physical depreciation takes into account normal wear of the structure and its components. These depreciation items might or might not be repairable. Functional obsolescence takes into account factors those features that make the property less desirable or marketable, such as outdated design, decorating, or appliances. These items might or might not be repairable. External obsolescence takes into account factors that make the property less desirable, but are out of the control of the homeowner, such as a deterioration of the neighborhood.]

Using the Sales Comparison Approach, the appraiser estimates a subject property's market value by comparing it to similar properties that have sold in the area. The properties used are called comparables, or comps. Since no two properties are exactly alike, the appraiser studies the differences in the comp properties and makes paperwork adjustments to bring their features more in-line with the subject property. The give-and-take result is a figure that shows what each comp would have sold for if it had the same qualities as the subject. An appraiser's report typically shows side-by-side comparisons of three comparables. The appraiser evaluates and describes the overall real estate market in the area. Real estate agents use comps to help home sellers determine a realistic asking price, but an appraiser's report is much more detailed. As the most practical measure of value, to a lender, is the actual market value of the property, most appraisals are heavily weighted in favor of the Sales Comparison Approach.

Using the Sales Comparison Approach, all above-grade square footage in the structure having comparable quality of finish quality is generally valued equally, regardless of the actual cost to construct. This is not true, however, of below-grade square footage, such as basements, which is usually assigned a value that may be as little as 50 percent of that assigned to the above-grade square footage in the same structure. The equal valuation given all above-grade square footage by the Sales Comparison Approach, regardless of cost, is an anomaly of the appraisal process that makes the present invention possible.

Up until about fifty years ago, residential home construction generally utilized a roof structure including rafters, bracing, and a full-span, load-carrying beam, sawn from old-growth timber and running perpendicular to the rafters, assembled at its permanent location at the job site. Rafter pairs were typically nailed directly to the top plate of opposing outer walls and to the full-span beam. One brace typically connected each rafter to a ceiling joist, with each pair typically forming an equilateral triangle with the ceiling joints, and each brace forming a smaller equilateral triangle with its associated rafter and the associated ceiling joist. In order to convert an attic to a room, the braces could be relocated to a vertical position, thereby becoming the wall studs for the attic room, yet maintaining a triangulated structure. In the late 1950s, this method of construction was rapidly replaced with a system involving full-span roof trusses. Each roof truss was fully engineered, featured extensive triangulation, eliminated the need for old-growth timber, and resulted in a roof that was stronger than that provided by the old method of construction. The down side to the use of roof trusses was that they filled up the space under the roof with bracing so that it could no longer be used for storage or converted into livable space. As the full-span trusses are engineered for optimum strength with minimum weight, and are assembled with stamped steel nail plates, any post-construction modification of the trusses is extremely difficult, and must be engineered. FIG. 1 shows a typical full-span roof truss 100, which features a cantilevered design. As full-span trusses came into almost universal use, builders began to insulate ceilings with blow-in insulation, in order to reduce heating and air conditioning costs.

With the disappearance of attics, basements became much more popular in many parts of the country. Not only did basements have adequate and uniform headroom, they were easier to finish than attics, did not require a pull-down access stairway, and were less costly to heat and air condition year round than attics.

Today, and particularly in areas where builders are raising the roof pitch for aesthetic reasons, attics are making a comeback. Though, for a typical 2,300 square-foot home, the cost to excavate and build an unfinished basement averages about $25,000, a completely finished 400 square foot bonus room can be built above a garage for about a third that amount. The key to the low cost of construction is what is known as the attic truss. Most production builders use what is known as a “space saver” attic truss that is configured so that a room can be built under the peak of the roof. A typical space saver attic truss 200 is shown in FIG. 2 of the drawings. Although attic trusses are considerably more expensive than standard roof trusses, primarily due to the fact that the bottom chord of the truss, which is typically a 2×8, 2×10 or 2×12, also serves as a floor joist, the cost differential of using attic trusses typically increases the total cost of starter-type home by only about five percent. As a general rule, the finished area under the roof is of a standard space saver attic truss is about one-third as wide as the floors below. Using standard space saver attic trusses, the cost is about $15,000 to $20,000 to add an additional 800 square feet to the average-size 2,400 square-foot new house. Other types of attic trusses are available that extend the width of the attic room. Although these trusses are built in a variety of ways, a common feature is a vertical heel, or knee, that provides a pony wall above the top plate of the bottom floor wall. This feature increases headroom for full-span attic rooms. One of the drawbacks to the trusses providing full-span attic rooms is that the floor spans are limited by the 2×8, 2×10 or 2×12 lumber used to form the bottom chord of the trusses. FIGS. 3 and 4 of the attached drawings show two different types of attic trusses, each of which has a heel. The heel 301 of the truss 300 of FIG. 3 does not function as the interior wall of the attic room. This type of truss is able to span greater distances than the truss of FIG. 4, because the lower chord 302 (the central portion of which also functions as a floor joist) is braced for a distance away from the heel 301 by a pair of vertical braces 303 and a pair of diagonal braces 304. On the other hand, the truss 400 of FIG. 4 has a heel 401 that functions as both the interior and exterior vertical wall of the attic room.

### SUMMARY OF THE INVENTION

Though the present invention does not pretend to be able to cure all the social and economic ills of this country, it does have the capability to provide more affordable housing for the masses and, particularly, for those having a combined family income of at least $16 per hour in 2003 dollars. In addition, it has the added benefit of providing disciplined individuals with funds to invest, and thereby create wealth that can be used for retirement, a cushion for difficult times, education, or even consumption.

This invention includes a method of doing business which includes at least the steps of: constructing a home using modified attic trusses to minimize construction costs per unit size and maximize the above-grade size thereof; selling the home for less than its appraised value, in order to provide a buyer with equity in the home; and arranging financing of the home using a mortgage that is less than fully amortized.

For a preferred embodiment of the invention, the method also includes the steps of: establishing a business entity having construction, sales, mortgage brokering, and investment functions; providing credit clean-up services to prospective buyers; providing multiple home designs from which the buyer may select; arranging an initial financing or a subsequent refinancing of the home at or in excess of its appraised value with a mortgage requiring payment of only interest during its term; and providing investment services which enable the buyer to invest, preferably on a continuing basis, an amount corresponding to at least a partial pay-back of principal on a conventional long-term mortgage.

Also for a preferred embodiment of the invention, each of the construction, sales, mortgage brokering, and investment functions may be operated for profit by the business entity.

Standard home appraisal rules dictate that only floor space where the ceiling is at least 5 feet in height be counted in the total square footage of the structure. Therefore, in order to maximize the amount of countable attic room space, and still keep the pitch of the majority of the roof at no more than 8:12 or about 34 degrees (roofing labor costs typically double for pitches greater than 8:12), a modified attic truss is used which has a vertical component at each end known as a “heel” or “knee” that, with the other parallel trusses, forms a stub wall superjacent the plate of the first story wall. The bottom of each heel is tied to one end of the truss' bottom chord, which is also designed to function as a floor/ceiling joist. Although the heel of each truss may be up to 4 feet or more in height, a heel height of 2 to 3 feet is generally used, as the width of the attic room is limited by the length that the bottom chord of the truss can span. By using attic trusses with heels, the usable square footage of the attic story as a fraction of the underlying floor can typically be increased from about one-third to about one-half. Using this method, square footage can be added to a house as attic rooms for about 35 percent of the cost of on-grade square footage. One of the elements of this invention is that of maximizing the square footage of a home to be built by utilizing all available attic space as living space. By doing so, the cost of the home, per square foot of living area, is minimized. At the same time, the market value of the home is determined by the total above-grade square footage of the structure, with the ground-level space and the attic space being valued the same, even though the latter cost less to build.

### BRIEF DESCRIPTION OF THE DRAWINGS

FIG. 1 is a front elevational view of a standard roof truss;

FIG. 2 is a front elevational view of a standard “space saver” attic truss;

FIG. 3 is a front elevational view of a first modified attic truss;

FIG. 4 is a front elevational view of a second modified attic truss;

FIG. 5 is a front elevational view of a new full-span attic truss incorporating a center vertical floor brace that doubles as a wall stud for an attic dividing wall;

FIG. 6 is a front elevational view of a new full-span attic truss incorporating a pair of central vertical floor braces that double as wall studs for the walls of a hallway;

FIG. 7 is a front elevational view of a new full-span attic truss incorporating a scissor-cantilever lower chord;

FIG. 8 is a front elevational view of a new full-span attic truss incorporating a modified Warren floor truss;

FIG. 9 is a right-side elevational view of a starter home constructed using attic trusses throughout;

FIG. 10 is a front elevational view of the starter home of FIG. 9;

FIG. 11 is a left-side elevational view of the starter home of FIG. 9;

FIG. 12 is a rear elevational view of the starter home of FIG. 9;

FIG. 13 is a top plan view of the foundation and floor plan of an optional basement for the starter home of FIG. 9;

FIG. 14 is a top plan view of the main floor plan for the starter home of FIG. 9;

FIG. 15 is a sectional view, taken through the covered front porch, and showing the framing layout, including the orientation of the attic trusses;

FIG. 16 is a sectional view showing the detail of the ridge beams;

FIG. 17 is a sectional view, taken through the two stairways;

FIG. 18 is a top plan view showing the layout of the attic trusses and roof framing;

FIG. 19 is a top plan view of the attic floor plan;

FIG. 20 is a right-side elevational view of an upscale starter home constructed using attic trusses throughout;

FIG. 21 is a front elevational view of the upscale starter home of FIG. 20;

FIG. 22 is a left-side elevational view of the upscale starter home of FIG. 21; and

FIG. 23 is a rear elevational view of the upscale starter home of FIG. 20.

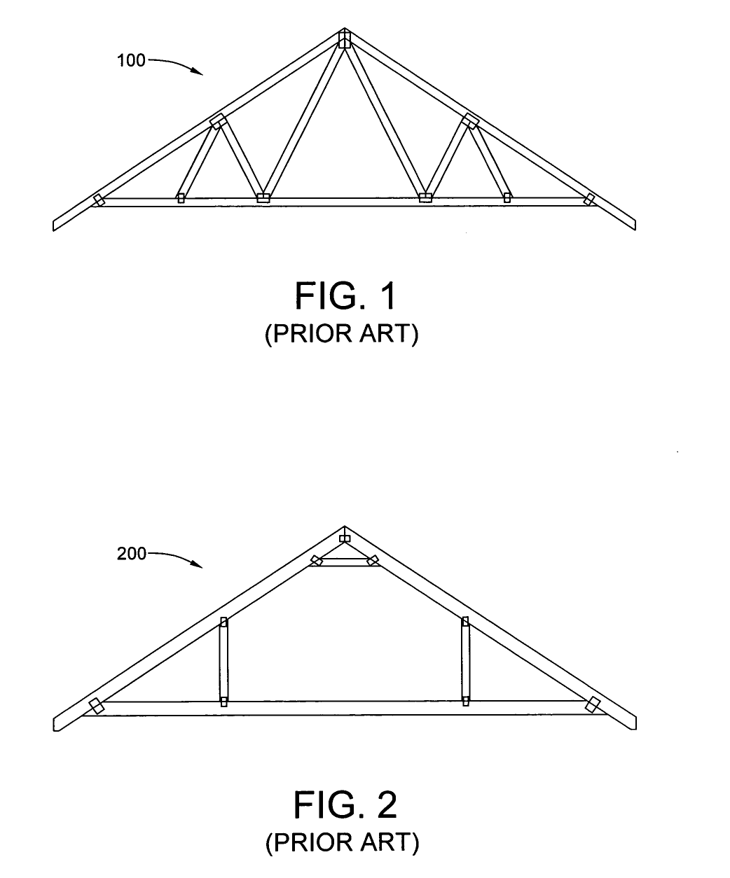

### DETAILED DISCLOSURE OF THE INVENTION

This invention includes a method of doing business which includes at least the steps of: constructing a home using modified attic trusses to minimize construction costs per unit size and maximize the above-grade size thereof; selling the home for less than its appraised value, in order to provide a buyer with equity in the home; and arranging financing of the home using a mortgage that is less than fully amortized.

Standard home appraisal rules dictate that only floor space where the ceiling is at least 5 feet in height be counted in the total square footage of the structure. One of the elements of this invention is that of maximizing the square footage of a home to be built by utilizing all available attic space over five feet in height as living space. By doing so, the cost of the home, per square foot of living area, is minimized. At the same time, the market value of the home is determined by the total above-grade square footage of the structure, with the ground-level space and the attic space being valued the same, even though the latter cost less to build.

Although the present focus of this invention is the construction of starter homes having about 1,700 square feet of above-grade living space, including the attic room space, plus about 800 square feet of basement living space, the invention may be applied, as well, to larger homes.

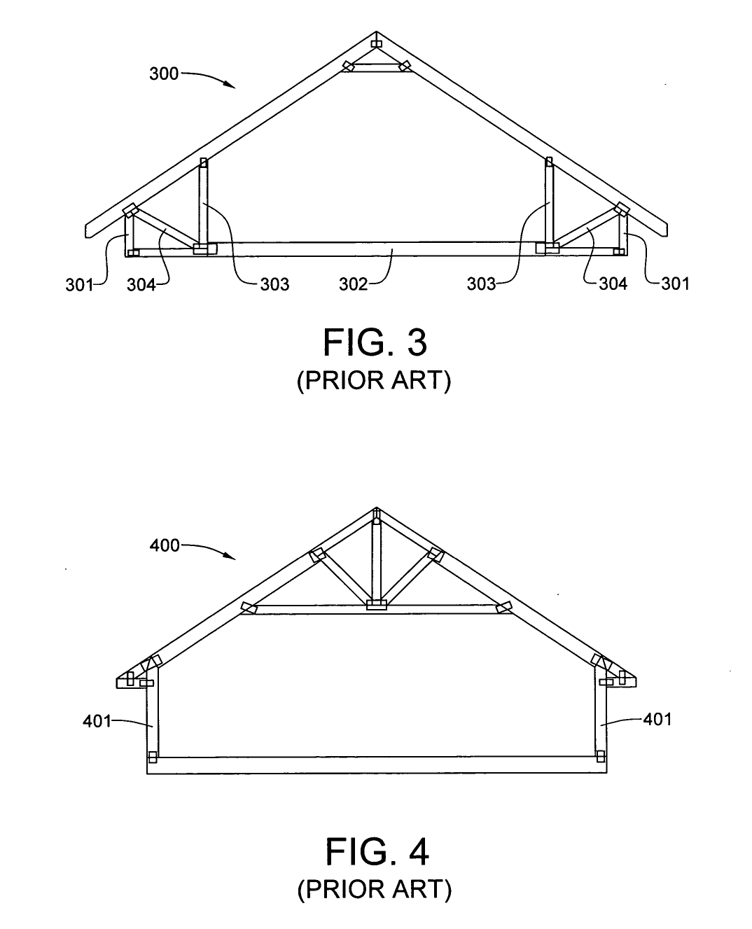

For the step of constructing a home using modified attic trusses to minimize construction costs per unit size and maximize the above-grade size thereof, one or more of many available attic truss designs may be used in the structure. There are a number of competing considerations involved in the decision of which truss design or designs to use. The first is roof pitch. Because OSHA requires that roofing workers be tethered to the roof for pitches greater that 8:12 (resulting in near double roofing labor costs), it is most economical to add attic space using roof pitches no greater than 8:12, where possible. As this relatively gentle pitch severely limits wall height toward the ends of the span, conventional space saver trusses, such as the one depicted in FIG. 2, are generally avoided because of the limited amount of additional attic space that they afford. In order to increase square footage of the attic room space, attic trusses similar to those of FIG. 3 and FIG. 4 may be used. Each of these trusses 300 and 400, respectively has a heels 301 or 401, which increase headroom toward the ends of the truss. The heels 301 of the truss 300 of FIG. 3 forms an outer wall above the top plate of the ground floor walls, while the vertical braces 303 form an interior wall that also helps support the lower chord 302. Thus, the truss 300 of FIG. 3 may be used to span greater distances, as the unbraced length of the bottom chord is shorter than that of the truss of FIG. 4 for equal spans.

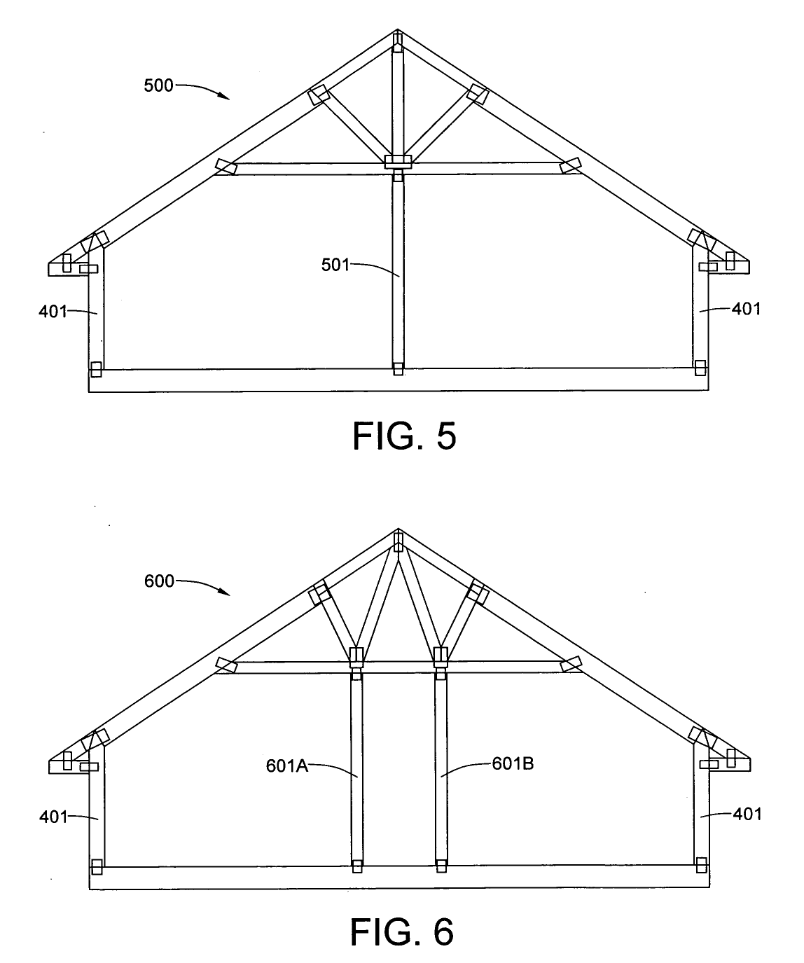

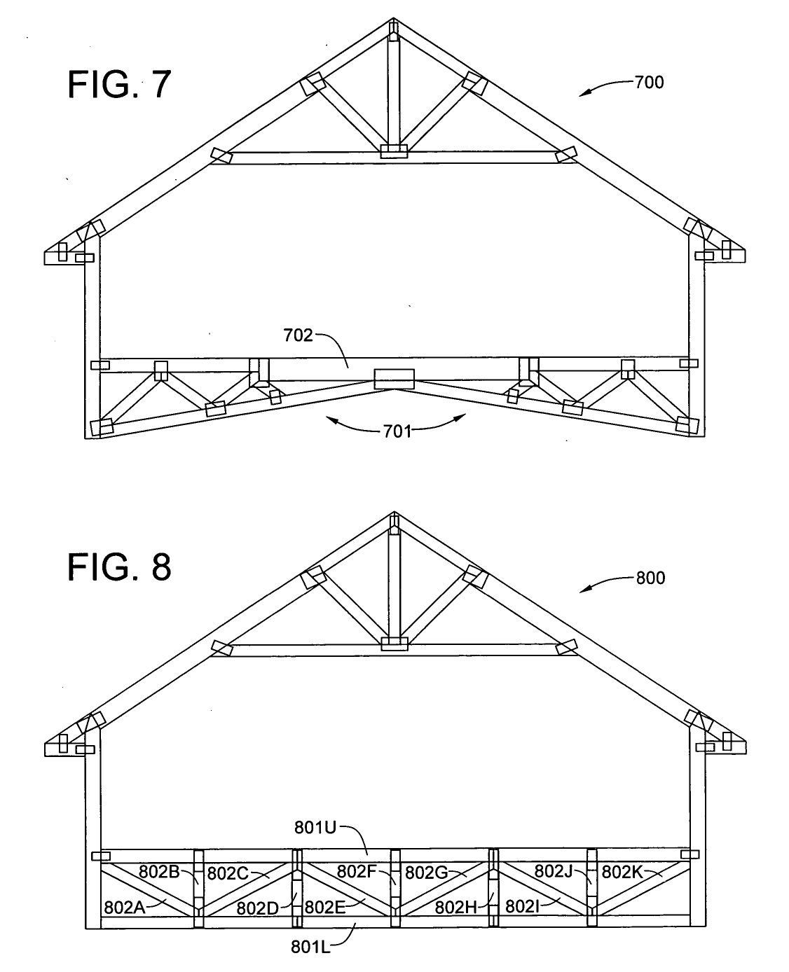

The trusses 500, 600, 700 and 800 of FIG. 5, FIG. 6, FIG. 7 and FIG. 8, respectively, have been designed by Angus C. Fox, IlIl of Provo, Utah. Although these trusses are not considered part of the present invention, they may be used to implement the method of the present invention. These full-span trusses may be used to span larger distances than the truss 400 of FIG. 4. The attic truss 500 of FIG. 5 employs a vertical brace 501 that doubles as a wall stud for a dividing wall down the center of the attic space, while the attic truss 600 of FIG. 6 employs a pair of vertical braces 601A and 601B, which double as wall studs for a hallway centered within the attic space. The attic truss 700 incorporates a modified scissor truss structure 701 as the lower chord of the truss. In order to increase the live load capacity of this truss, flat steel reinforcing plates or stamped steel U-beam reinforcing plates may be adhesively and/or mechanically bonded to the center upper-bottom chord 702. The truss of FIG. 7 also has the advantage of providing a vaulted ceiling in for the main floor below. The attic truss 800 of FIG. 8 incorporates a modified floor truss as the bottom chord. The floor truss differs from conventional floor trusses in that the cord sections 801U and 801L and the bracing members 802A-802K are rotated 90 degrees from the conventional orientation, so that the edges of the lumber are facing either up or down, rather than sideways. Though the attic truss 800 is able to span distances comparable to those spanned by conventional floor trusses, it does not provide a vaulted ceiling.

It should, of course, be obvious that a truss having any length span may be used for attic rooms if load-bearing walls are placed in appropriate locations below the bottom chord.

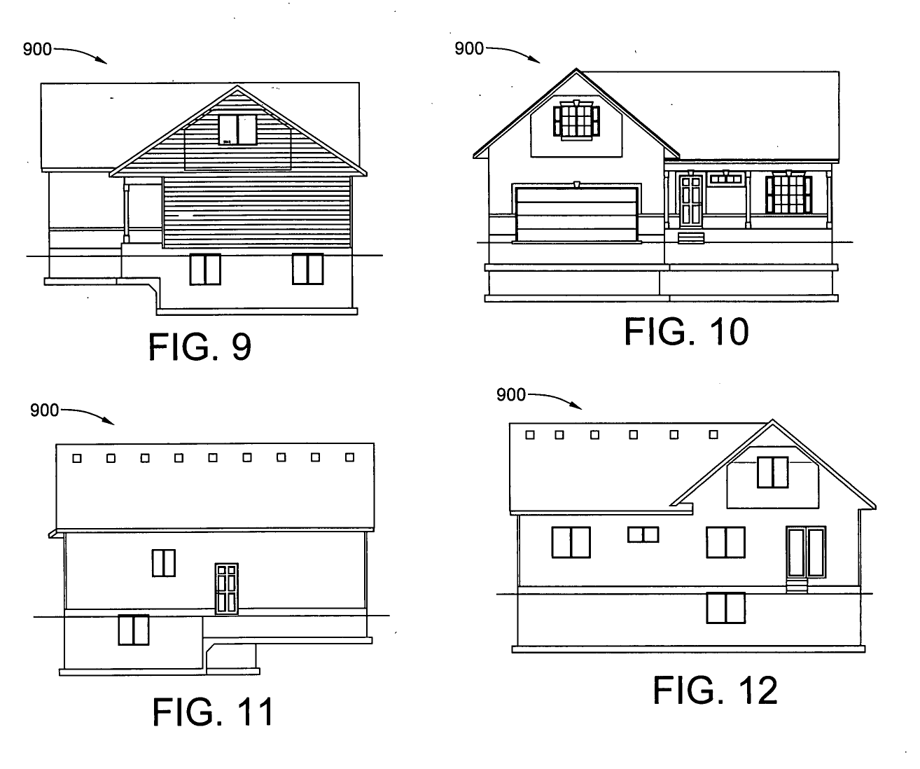

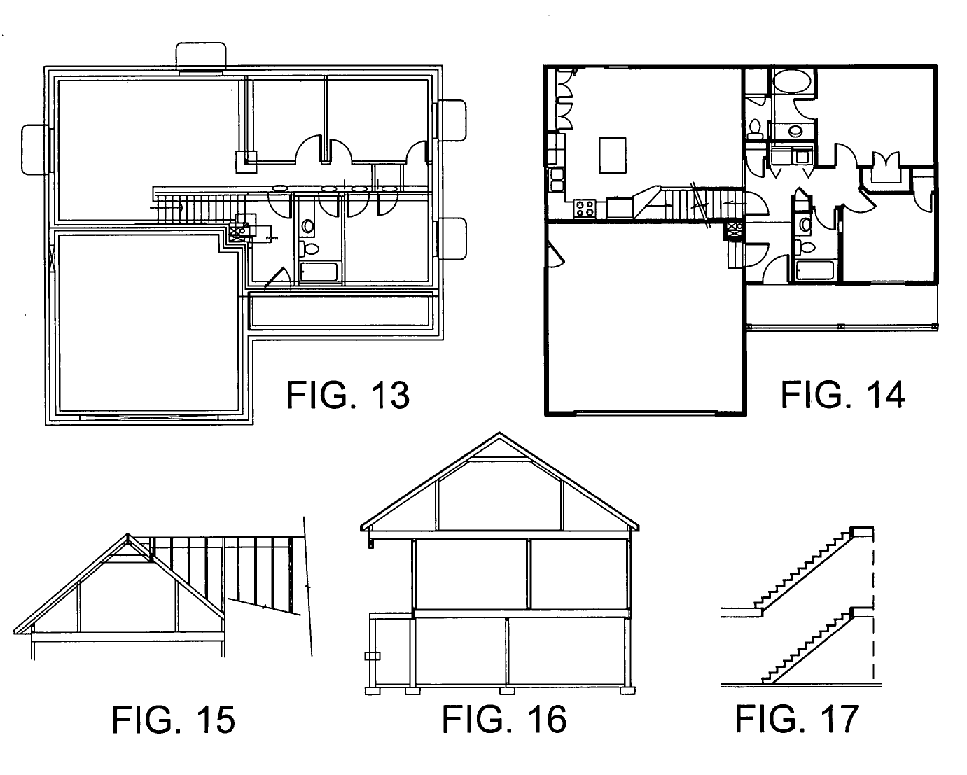

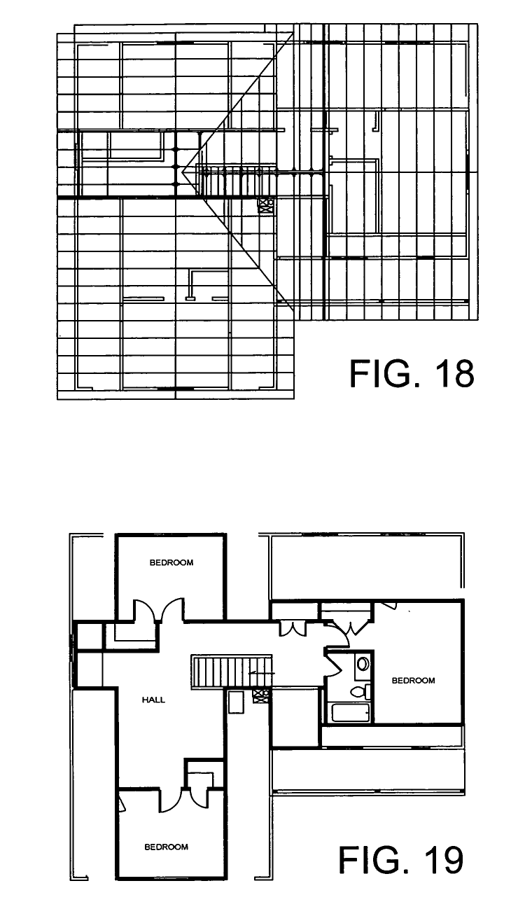

FIGS. 9 to 19 show various aspects of a starter home 900 constructed using attic trusses throughout to increase square footage of the structure. It should be noted that these are simplified construction plans that are included in this disclosure to illustrate the method of construction using attic trusses throughout the structure. FIGS. 9 shows the right side of the home; FIG. 10, the front thereof; FIG. 11, the left side thereof; and FIG. 12, the rear thereof. FIG. 13 shows the footing/foundation plan and floor plan for an optional basement; FIG. 14 shows the main floor plan; and FIG. 19 shows the attic floor plan. FIG. 15 shows the framing layout, including the orientation of the attic trusses on the main part of the house; FIG. 16 shows the detail of the ridge beams in the main part of the house and the attic truss orientation over the garage; and FIG. 17 shows the layout of the three stairways, the bottom stairway leading from the basement to the main floor, and the upper stairway leading from the main floor to the habitable attic space.

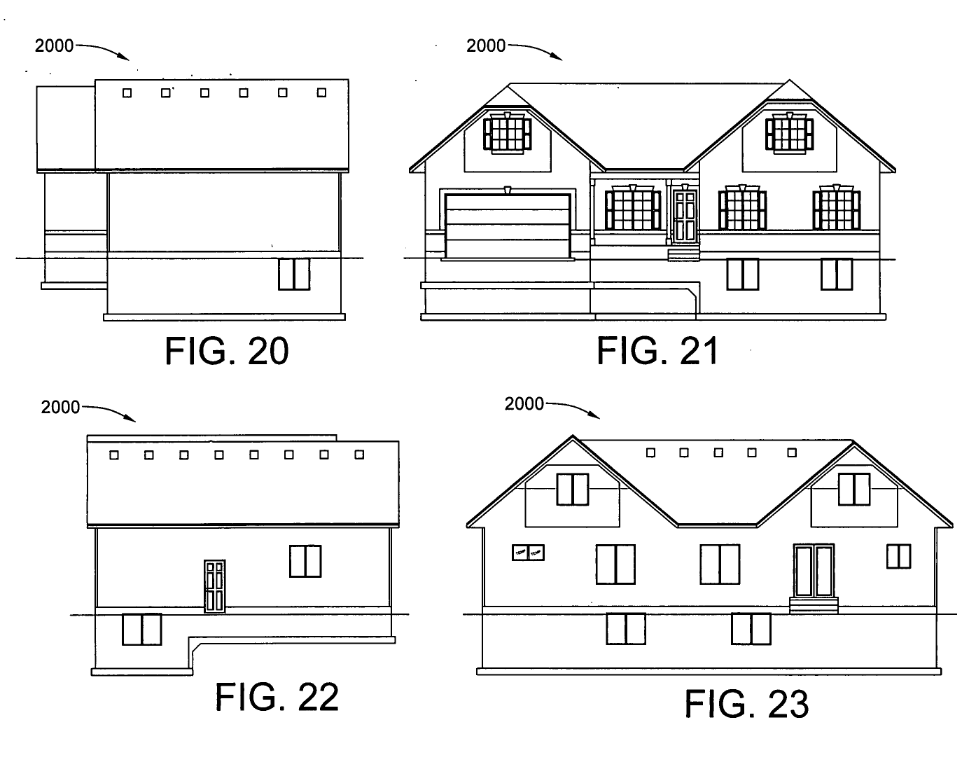

FIGS. 20 to 23 show the exterior views of an upscale starter home 2000 that is also constructed using attic trusses throughout. FIG. 20 shows the right side of the structure; FIG. 21 shows the front thereof; FIG. 22 shows the left side thereof; and FIG. 23 shows the rear thereof.

FIG. 21 is a front elevational view of the upscale starter home of FIG. 20;

FIG. 22 is a left-side elevational view of the upscale starter home of FIG. 21; and

FIG. 23 is a rear elevational view of the upscale starter home of FIG. 20.

As the cost of adding attic room space is about 35 percent of the cost of adding main floor square footage, the difference between the cost and the appraisal of the attic room square footage is passed, in whole or in part, to the buyer. The sale of a home constructed with attic trusses for less than its appraised value is, essentially, a gift to the buyer. This gift has three primary functions. The first is to provide the home buyer with a substantial amount of equity when he takes possession of the home. This equity makes it possible for families having household incomes as low as $16 per hour in 2003 dollars, to purchase a starter home having a total of about 1,700 square feet of above-grade living space. The second is to increase the demand for these houses built with attic trusses is in order to give the builder a competitive advantage. Rapid sales of these homes will increase cash flow for builders by greatly reducing financing costs of the builder's unsold inventory of homes.

The step of arranging financing of the home using a mortgage that is less than fully amortized allows the home buyer to implement a savings plan, which in thirty years can not only pay off the house, but generate a considerable amount of wealth that may be used for retirement, education, or consumption. An interest only mortgage is preferably obtained for the buyer. This allows the buyer to invest what would normally be the payback of principal into investments having an interest payback greater than the mortgage interest rate. In addition, the buyer may obtain a mortgage for the total appraised value of the home and invest the difference between his purchase cost (including transaction and mortgage fees) and the appraised value. In the past, buyers who wanted to avoid paying mortgage insurance typically had to limit their mortgages to less than 80 percent of the appraised value. As a rule, those buyers who paid mortgage insurance were those who could least afford it. In other words, the payment of mortgage insurance actually increased the probability that the buyer would default during the mortgage term. Today, a variety of financing options are available to home buyers, including mortgages that cover up to about 105 percent of the appraised value.

For a preferred embodiment of the invention, the method also includes the steps of: establishing a business entity having construction, sales, mortgage brokering, and investment functions. Each of these functions may be operated by the business entity as a profit center. There may be certain state prohibitions against a single entity providing both real estate sales and mortgage brokering functions.

As many of the individuals who may benefit most from the present invention have poor credit, another aspect of the invention is the step of providing credit clean-up services to prospective buyers before they apply for a home finance loan.

The business entity may provide multiple home designs, all of which utilize attic trusses to economically increase the size of the home.

In addition, for cases where the buyer is prohibited from or unable to finance the purchase of the home for the appraised value, the business entity may desire to provide after-sale refinancing services so that the buyer may optimize his investment opportunities.

Although only several embodiments of the present invention have been disclosed herein, it will be obvious to those having ordinary skill in the art that changes and modifications may be made thereto without departing from the scope and spirit of the invention as hereinafter claimed.

1. A method of doing business including the steps of:
constructing a home using attic trusses to minimize construction costs per unit size and maximize the above-grade size thereof;
selling the home for about ten to twenty percent less than its appraised value, in order to provide a buyer with equity in the home;
arranging financing of the home using a mortgage that is less than fully amortized; and
providing investment services which enable the buyer to an amount corresponding to at least a partial pay-back of principal on a conventional long-term mortgage.

2. The method of claim 1, wherein said mortgage requires the payment of only interest during its term.

3. The method of claim 1, which further comprises the step of establishing a business entity having construction, sales, mortgage brokering, and investment functions, said business entity performing directly or arranging for the performance of the steps of the method.

4. The method of claim 1, wherein said business entity arranges for financing of the home at about its appraised value, and the amount invested also includes at least a portion of the difference between the appraised value and the sale price plus transaction fees related to the sale and financing.

5. The method of claim 1, wherein said business entity arranges for financing of the home in excess of its appraised value, and the amount invested also includes at least a portion of the difference between the financed value and the sale price plus transaction fees related to the sale and financing.

6. The method of claim 1, which further comprises the step of providing credit clean-up services to a prospective buyer.

7. The method of claim 1, which further comprises the step of providing multiple home designs from which the buyer may select.

8. The method of claim 1, wherein each of said construction, sales, mortgage brokering, and investment functions may be operated for profit by said business entity.

9. The method of claim 1 wherein, at the time of sale, the home is financed for an amount that is less than or equal to the purchase price, and said business entity subsequently arranges a refinancing of the home at an amount about equal to the appraised value.

10. A method of doing business including:
establishing a business entity having construction, sales, mortgage brokering, and investment functions, each function having profit potential;
providing multiple home plans which utilize attic trusses to minimize construction costs per unit size and maximize the above-grade size thereof;
constructing an inventory of homes using the plans provided;
selling the home for less than its appraised value, in order to provide a buyer with equity in the home;
arranging financing of the home using a mortgage that is less than fully amortized; and
providing investment services which enable the buyer to invest an amount corresponding to at least a partial pay-back of principal on a conventional long-term mortgage.

11. The method of claim 10, which further comprises the step of the business entity arranging a refinancing of the home in order to increase both the loan amount secured by the home and the amount invested by the buyer.

12. The method of claim 10, wherein said mortgage requires the payment of only interest during its term.

13. The method of claim 10, wherein said business entity arranges for financing of an amount secured by the home that is greater than the purchase, and the amount invested also includes at least a portion of the difference between the financed amount and the sale price plus transaction fees related to the sale and financing.

14. The method of claim 10, wherein said business entity arranges for financing of an amount secured by the home in excess of its appraised value, and the amount invested also includes at least a portion of the difference between the financed amount and the sale price plus transaction fees related to the sale and financing.

15. The method of claim 10, which further comprises the step of providing credit clean-up services to a prospective buyer.

16. The method of claim 10 wherein, at the time of sale, the home is financed for an amount that is less than or equal to the purchase price, and said business entity subsequently arranges a refinancing of the home at an amount about equal to the appraised value.

17. A method of doing business including:
constructing a home using attic trusses to minimize construction costs per unit size and maximize the above-grade size thereof;
selling the home for less than its appraised value, in order to provide a buyer with equity in the home; and
arranging financing of the home using a mortgage that is less than fully amortized.

18. The method of claim 17, wherein said mortgage requires the payment of only interest during its term.

19. The method of claim 17, wherein said home is sold for about ten to twenty percent less than its appraised value

20. The method of claim 17, which further comprises the step of establishing a business entity having construction, sales, mortgage brokering, and investment functions.

21. The method of claim 17, which further comprises the step of providing investment services which enable the buyer to invest, on a continuing basis, an amount corresponding to at least a partial pay-back of principal on a conventional long-term mortgage.

22. The method of claim 17, wherein said business entity arranges for financing of the home at about its appraised value, and the amount invested also includes at least a portion of the difference between the appraised value and the sale price plus transaction fees related to the sale and financing.

23. The method of claim 17, wherein said business entity arranges for financing of the home in excess of its appraised value, and the amount invested also includes at least a portion of the difference between the financed value and the sale price plus transaction fees related to the sale and financing.

24. The method of claim 17, which further comprises the step of providing credit clean-up services to a prospective buyer.

25. The method of claim 17, which further comprises the step of providing multiple home designs from which the buyer may select.

26. The method of claim 17, wherein each of said construction, sales, mortgage brokering, and investment functions may be operated for profit by said business entity.

27. The method of claim 17, wherein, at the time of sale, the home is financed for an amount that is less than or equal to the purchase price, and said business entity subsequently arranges a refinancing of the home at an amount about equal to the appraised value.
